(19) United States
(12) Patent Application Publication
(10) Pub. No.: US 2009/0036136 A1
(43) Pub. Date: Feb. 5, 2009

(54) Apparatus and Method for Hierarchical Routing with a Look-Ahead Mechanism

(75) Inventors: Joseph Grosskopf, Park Ridge, IL (US); Frances Mu-Fen Chin, Naperville, IL (US); Karen Hotze, Northfield, IL (US); Mark Richert, Wheaton, IL (US); Larry Wierzbicki, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: LUCENT TECHNOLOGIES INC., Murray Hill, NJ (US)

(21) Appl. No.: 11/833,888

(22) Filed: Aug. 3, 2007

(51) Int. Cl. H04Q 7/20

(52) U.S. Cl. 455/445

(57) ABSTRACT

A system and a method for hierarchical routing with a look-ahead mechanism is disclosed. The method includes originating a call having an origination point in a first form through a first region. The method continues with routing the call to the originating MSC and then to a first internet protocol tandem associated with the first region. The method continues with forwarding the call to a second internet protocol tandem associated with a second region. The second region is generally the destination region. The method continues with determining whether or not the call qualifies as a call that may be terminated in a second form and if the call does qualify to be terminated in the second form, rerouting the call back to the original mobile switching center and connecting the call to the termination point in the second form, i.e., a circuit based form.

### BACKGROUND OF THE INVENTION

This invention relates to an apparatus and method for hierarchical routing with a look-ahead mechanism. More particularly, this disclosure relates to a method and apparatus for a telecommunications service provider to use an Internet Protocol (IP) tandem in order to a) determine whether a called party is a customer of the service provider and b) drop the call back to the originating MSC for re-routing via an alternate route when the called party is NOT a customer of the service provider.

While the disclosure is particularly directed to a particular telecommunications architecture and thus will be described with specific reference thereto, it will be appreciated that this disclosure may have usefulness in other fields and applications. For example, this disclosure may be used in a variety of data transfer systems in order to support rerouting during call set up. Furthermore, this disclosure will enable an originating MSC to utilize IP tandems for hierarchical network routing. The system and method may also be used to simplify the inter-MSC trunk network and reduce trunks between MSCs for call delivery.

By way of background, telecommunications service providers ideally would like to use a hierarchical method in order to connect calls throughout the telecommunications network. Hierarchical methods allow for the reduction of provisioning within MSCs. In this sense, it is not necessary for each MSC to define a packet route to every other MSC in the network. Many service providers currently use a hierarchical architecture in order to route circuit based calls.

Service providers are currently utilizing technologies under the 3^{rd} Generation Partnership Project 2 (3GPP2). These technologies include the use of Transcoder Free Operation (TrFO) which transports compressed speech from compatible mobile stations in a packet transport network. TrFO eliminates unnecessary coding and decoding of signals by intermediate elements in the network. One major problem with implementing this technology is the intensive provisioning required at each MSC in order to define all of the signaling end points in the packet network. Without a hierarchical architecture, it is necessary to provision extensive routing translations at each MSC to provide detailed inter-MSC and inter-regional routing translations.

There is a need in the industry for the service provider to have a method such that calls may be routed over the packet network with minimal impact to MSC provisioning. Furthermore, there is a need in the industry for the service provider to provide a way for originating MSCs to route calls to their subscribers via their own packet network. There is also a need in the industry for the service provider to allow their originating MSCs to reroute calls to non-service provider subscribers through a specified interexchange carrier network (which may be circuit based). The reroute mechanism must be able to be located at the point in the network where the final destination of the call is known.

The present disclosure contemplates a new and improved architecture that resolves the above-referenced difficulties and others.

### SUMMARY OF THE INVENTION

A hierarchical method and system that simplifies the inter-MSC trunk network without modifying standard based number portability is provided. This disclosure allows service providers to restrict the use of their packet network to calls that meet predetermined criteria, e.g. calls between their own subscribers This disclosure also does not require a significant increase in the amount of MSC provisioning.

In one aspect of the disclosure, the method includes originating a call having an origination point in a first form through a first region; routing the call to an originating mobile switching center; routing the call to a first internet protocol tandem associated with the first region; forwarding the call to a second internet protocol tandem associated with a second region; determining whether or not the call qualifies as a call that may be terminated in the first form; and if the call does not qualify to be terminated in the first form, rerouting the call back to the originating mobile switching center and connecting the call to the termination point in the second form.

In accordance with another aspect of the present disclosure, the method includes querying a number portability database in order to assist in determining whether the call qualifies as a call that may be terminated in the first form or whether the call must be rerouted back to the originating MSC to be completed in the second form.

In accordance with another aspect of the present disclosure, the method includes that the number portability database is locally associated with the second region.

In accordance with another aspect of the present disclosure, the method includes that the first form is packet based.

In accordance with another aspect of the present disclosure, the method includes forwarding a packet-to-circuit indicator that signals the originating mobile switching center to reroute the call via a circuit network.

In accordance with another aspect of the present disclosure, the method includes that the call qualifies as a call that may be terminated in the first form if the termination point and origination point are associated with a common service provider.

In accordance with another aspect of the present disclosure, the method includes that the second form is circuit based.

In accordance with another aspect of the present disclosure, the method includes that if the call does not qualify to be routed in the second form, routing the call to a second mobile switching center that is associated with the termination point.

In accordance with another aspect of the present disclosure, the method includes that the call includes a signaling path.

In accordance with another aspect of the present disclosure, the system that supports network-based route advancing for a call in one form to another comprises a mobile switching center configured to forward a call and convert the call from a packet based call to a circuit based call; a first internet protocol tandem in a first region that receives the call from the mobile switching center; a second internet protocol tandem in a second region configured to receive the call from the first internet protocol tandem and implement predetermined criteria in order to qualify a call is a call that is to be converted to a circuit based call; and a database that stores qualifying information for the second region.

In accordance with yet another aspect of the present disclosure, the system includes that the database is a regional wireless number portability database.

In accordance with another aspect of the present disclosure, the system includes a home location register configured to locate a second mobile switching center associated with a termination point for the call if the call does not qualify as a call that is to be converted to a circuit based call.

According to another aspect of the present disclosure, the system includes that the call qualification is based, at least in part, on whether the call is an intra-network call.

According to another aspect of the present disclosure, the system includes that qualifying information includes call connection information.

According to another aspect of the present disclosure, the system for hierarchical call routing with a look-ahead mechanism includes a mobile switching center in first region configured to route a call over a packet network and reroute the call over a circuit network if it meets a rerouting criteria; a query module configured to query a database in order to determine if the call meets the rerouting criteria; and a rerouting module that reroutes the call back to the mobile switching center if the call meets the rerouting criteria.

According to another aspect of the present disclosure, the system includes a home location register that is queried in order to find which mobile switching center the call's termination point is visiting in order to connect the call if the call does not meet rerouting criteria.

According to another aspect of the present disclosure, the system includes that the database is a wireless number portability database.

According to another aspect of the present disclosure, the system includes that the circuit network includes a public switched telephone network.

According to another aspect of the present disclosure, the system includes that the call has an origination point and a termination point and rerouting criteria is not met if the origination point and termination point are supported by a common network provider.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communications network including a mobile station, a plurality of MSCs, plurality of IP tandems, Wireless Number Portability (WNP) regional databases, the IP network, and Public Switched Telephone Network (PSTN).

FIG. 2 is another illustration of the overall communications network.

FIG. 3 is a flow chart illustrating one embodiment of the method according to the present disclosure.

FIG. 4 is a detailed figure illustrating a smaller portion of the communications network.

### DETAILED DESCRIPTION

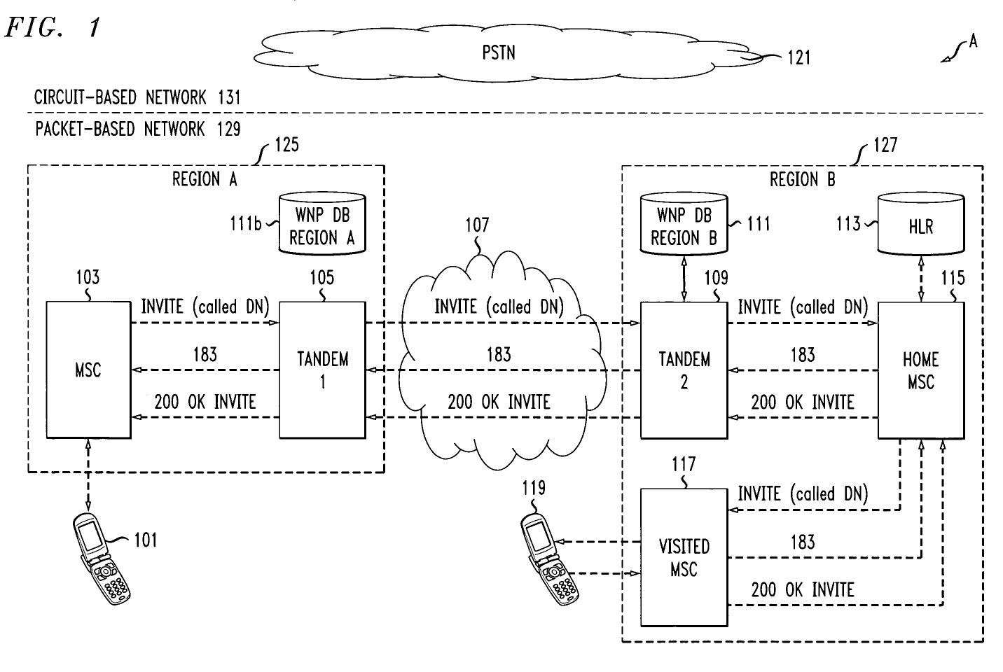

Referring now to the drawings wherein the showings are for purposes of illustrating the disclosed embodiments only and not for purposes of limiting the same, FIG. 1 provides an overall view of the system into which the present disclosure may be incorporated. A communications infrastructure A is shown. The communications infrastructure A includes an originating mobile station 101, a first region such as region A 125, the IP network 107, a second region such as region B 127, the terminating mobile station 119 and the circuit based network 131. Region A includes an MSC 103, a first IP tandem 105, and a regional WNP database 111B. Region B 127 includes its regional counterparts including a second IP tandem 109, home MSC 115, a Home Location Register (HLR) 113, a regional WNP database 111 and a visited MSC 117. It should be understood that this represents but one embodiment of the communications network infrastructure A. For example, different regions may be incorporated into the network. Those shown are merely exemplary. The present disclosure could be incorporated in a variety of communication network configurations, including those that utilize a single IP tandem.

In operation, as described in greater detail below, the presently described embodiments are directed towards a hierarchical routing network with look-ahead mechanism. In this sense, the disclosure describes a solution to the current problem of allowing for calls to be routed over the packet network with minimal MSC provisioning and without flat MSC cross connection routing translations.

Still referring to FIG. 1, the system includes an originating mobile station 101. As shown, the mobile station 101 may be in communication with an originating MSC 103. The originating MSC 103 is in turn in communication with the region A (first) IP tandem 105. The first IP tandem 105 may communicate through the IP network 107 to other regions, in this case, the region B (second) IP tandem 109. The second IP tandem 109 is in communication with the WNP database 111 as well as the home MSC 115 of the terminating mobile station 119. The home MSC 115 may also communicate with the HLR 113 and the visited MSC 117. The visited MSC 117 is in communication with the terminating mobile station 119.

As described in further detail below, this communication network may include other network elements, for example, switches, gateways, etc. These communication networks may also include cellular networks, Voice over Internet Protocol (VoIP) networks, the intranet, etc.

Continuing on with FIG. 1, this embodiment includes a mobile station 101 which is user equipment. However, other user equipment besides a mobile station may be substituted. Other examples of user equipment include, but are not limited to, wireless phones, VoIP phones, laptop computers, desktop computers, WiFi phones, etc. These devices are typical user equipment used to communicate through compatible lines. In this embodiment the originating mobile station 101 is a CDMA 3G1X handset.

Through this disclosure a mobile call is being placed from the originating mobile station 101 to the terminating mobile station 119. The network service provider may have qualifying criteria set up so that the call may be placed through a packet based network 129 as long as the call termination point 119 is associated with the service provider. In this embodiment, the termination point 119 is indeed associated with the service provider. This embodiment displays the signaling path for the call.

The call begins at the mobile station origination point 101 and travels to the originating MSC 103 in region A 125. The originating MSC 103 with minimal provisioning can identify that the call termination point is in another region. Through Session Initiation Protocol (SIP) messaging, the MSC sends an INVITE to the local IP tandem 105. The local IP tandem 105 is able to receive this INVITE and forward it through the IP network 107 to region B 127 where it is received by a second IP tandem 109. This second IP tandem 109 is responsible for region B 127.

At this point, the second IP tandem 109 may query the WNP database 111 in order to find qualifying information for the call. The qualifying information may include connection information which will detail where the call will be terminated. In this embodiment, the call does not meet qualifying criteria in order to be routed from packet form because the termination point is in the service provider's network.

The INVITE message continues on to the home MSC 115 of the terminating mobile station 119. The home MSC 115 may then send a ring back message in order that the mobile subscriber placing the call will hear audible ringing. In this embodiment, the ring message is a 183 SIP message.

The home MSG 115 may then query the HLR 113 in order to find the location of the terminating mobile station 119. In this embodiment, the terminating mobile station is visiting another MSC 117. The HLR 113 contains information that enables the network to find the visited MSC 117. The home MSC 115 then sends the INVITE message to the visited MSC 117.

The visited MSC 117 will then send a page to the called mobile station 119 signifying that the user is receiving a call. Once the called user answers the telephone call, the signal will be sent to the visited MSC 117. The visited MSC 117 will then send a 200 OK INVITE message back to the home MSC 115. The home MSC 115 will signal the 200 OK INVITE message back through the IP tandems 109, 105 back to the originating MSC 103 and connect the call, setting up the bearer path. In some embodiments, the bearer path may be connected directly from the originating MSC 103 to the visited MSC 117. However, generally the signaling path will continue to be connected as shown in FIG. 1.

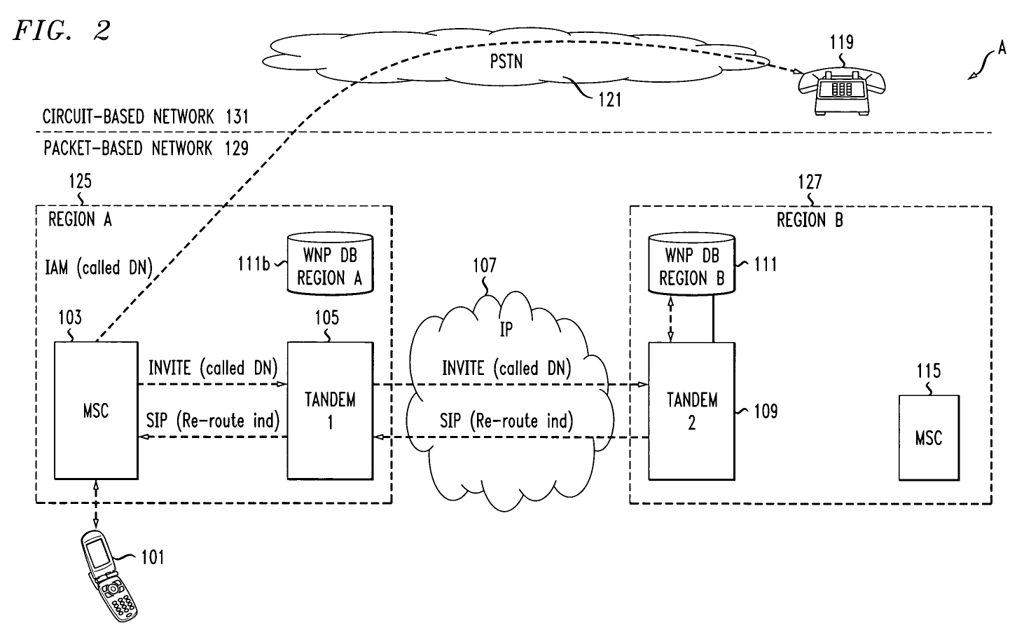

Now referring to FIG. 2 which shows another embodiment of the disclosure. FIG. 2 displays similar elements that were displayed in FIG. 1. However, the mobile station originating the call 101 is now attempting a call to a land line destination over the PSTN. In this embodiment, the call taking place is not terminated on the service provider's network. Therefore, it does meet the qualifying criteria and, in this embodiment, the call should not be carried over the packet network. However, under this disclosure the call will be allowed to utilize hierarchical routing. Stated another way, the MSC 103 will not require extensive routing translations to route inter-regional calls utilizing the packet network. The service provider will not be obligated to build translations for every switch so that every switch will point to every other switch in the packet network. This disclosure is particularly useful when a call is placed to a destination which is outside of the providing network as shown in FIG. 2.

Still referring to FIG. 2, network A is again shown. The originating mobile station 101 places a call and the call goes to the originating MSC 103. The originating MSC 103 continues the steps as outlined in FIG. 1 by sending an INVITE to the first IP tandem 105 which is in the originating MSC 103 region 125. The call is then forwarded from the first IP tandem 105 through the IP network 107 to the second IP tandem 109 which is in region B 127.

Unlike in FIG. 1, when the second IP tandem 109 queries the WNP database 111, the second IP tandem 109 determines that this call does not qualify to be terminated in a different form. This may happen for a variety of reasons. In one embodiment, the termination point may be outside of the service provider's network. In another embodiment, the wireless number dialed may be a ported-out wireless number. In another embodiment, the home MSC 115 is not equipped to handle packet-based calls. Furthermore, the service provider may not have provided a vocoder to allow for the handling of this situation. In other embodiments, the service provider may decide, for a variety of reasons, that this call may not be connected in this form. In this embodiment, it is determined that the call should be connected through circuit trunks.

The second IP tandem 109 will then send back a SIP message with information to indicate that the call cannot be completed over the packet network and should be rerouted to the circuit network. This message includes language that the originating MSC 103 will recognize as including a packet-to-circuit indicator. This message will be relayed from region B 127, second IP tandem 109 to region A 125, first IP tandem 105 into the originating MSCs 103.

The originating MSC 103 will then convert the call to a circuit based call and forward the call to the circuit based network 131. In this sense it will pass through the PSTN 121 in order to be connected at the termination point 119.

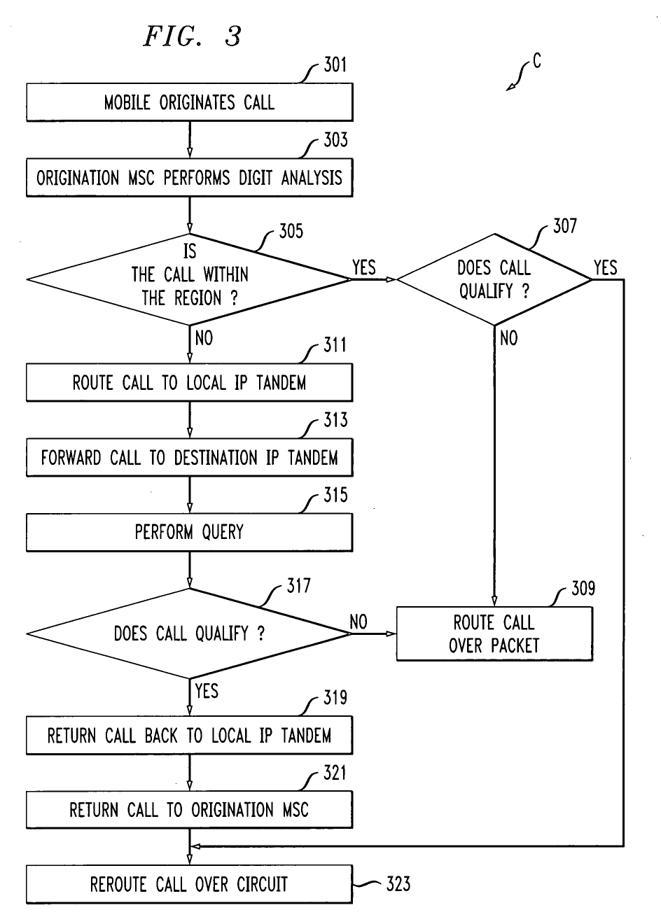

Now referring to FIG. 3 which is a flow chart illustrating one of the embodiments of the method according to the present disclosure. It should be understood that this method may be implemented by a variety of software and hardware configurations. It should also be understood that suitable software/hardware implementing the embodiments of the disclosure may also be distributed on any and/or all appropriate network elements.

The method begins with the mobile user originating the call on the originating mobile station 101 (at step 301). The call is then forwarded to the originating MSC 103 (FIGS. 1 and 2). The MSC 103 then performs digit analysis (at step 303). The next step in the method (at step 305) is to determine if the call is in the local region. If the call is in the local region, the MSC 103 will determine if the call qualifies as a call that should be routed over the circuit-based network (at step 307). If so, the call would be routed (at step 323) to the termination point in the circuit network. If the call does not qualify, the call will be routed over the packet-based network (at step 309). However, if the call is not in the region, the call would be routed to the local IP tandem 105 (at step 311).

Continuing on with FIG. 3, the call would then be forwarded to the second IP tandem 109 in the destination region 127 (at step 313). From there the second IP tandem 109 would query the WNP database 111 and/or would access routing information to find the relevant information concerning whether the call qualifies to be terminated in the first form (at step 315). The method continues (at step 317) with determining if the call qualifies to be terminated in a second form. If not, the call is routed to its proper destination continuing in its original form. This step may include querying an HLR and forwarding the call through home MSCs 115 and/or a visited MSC 117. This method of completing a call is generally known in the art and may be accomplished though a variety of known means.

In many situations, however, the call does not need to be rerouted, because it meets the qualifying criteria. However, if it is useful for the call to be rerouted, the call is rerouted to the first IP tandem 105 in the originating region 125 (at step 319).

The reroute may include a SIP message which will signal via an indicator that the call is to be routed through the circuit based network 131 in FIG. 2. This message will reach the original MSC 103 (at step 321).

The method concludes with rerouting the call over a circuit based network 131 (at step 323). The call will be completed and connected to its termination point 119 via a circuit based network.

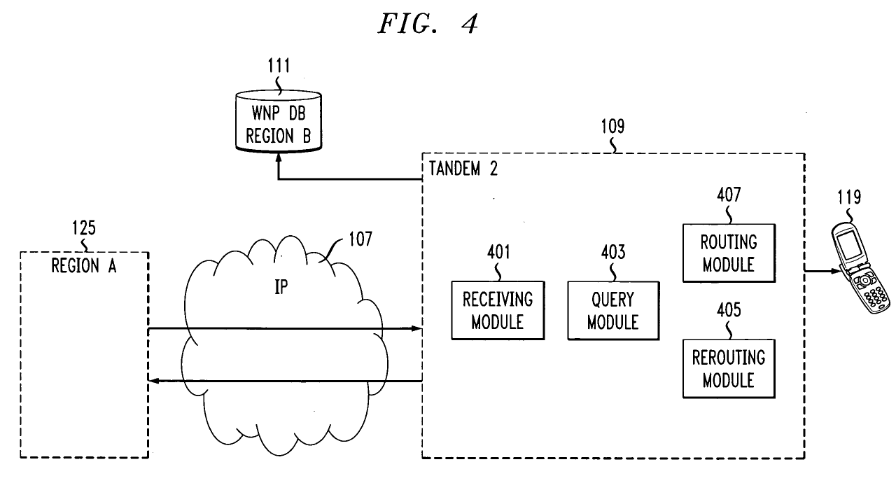

Now referring to FIG. 4 which is a detailed illustration of a portion of the network including the second IP tandem 109. The figure includes a query module 403, a rerouting module 405 and a routing module 407. Again, it should be noted that the system and method may be implemented in a variety of software and hardware configurations. This illustration is but one embodiment under the claimed disclosure.

The signaling path may be received in the receiving module 401 as it travels from the originating region 125 (FIGS. 1 and 2) to the destination region 127. The receiving module may then forward the call to the query module 403.

The query module 403 may then implement a query through its communication with the local WNP database 111. The query module 403 will then assist in determining which route the call will take.

The query may include a variety of factors, some or all of which may be determinative for whether the call will continue to be routed in one form or rerouted back to the originating MSC 103 to be converted into a different form and routed across a different path. The factors may include whether the termination point is within the service provider's network. The rerouting criteria may also include whether the destination MSC 115 is configured to accept a call in the first form. The rerouting criteria could also include if there is a vocoder (not pictured) available in order to convert the call to a different form. The service provider may provide a variety of methods, reasoning, or rationale in which the query module 403 may collect qualifying information. The qualifying information will generally include rerouting criteria and if the rerouting criteria are met, the call will be forwarded to the rerouting module 405.

The rerouting module, once it receives the call, will forward the call back to the first region 125 in order for the call to be converted to another form so that it may be sent to an alternative network, e.g. a circuit based network 131. The rerouting module 405 may include a packet-to-circuit indicator that signals the originating MSC 103 to reroute the call via a circuit based network 131. This message may be a standard SIP message or a non-standard message. In any form, the packet to circuit indicator will be recognized by the original MSC 103 and will signal that the originating MSC 103 should send the call in a different form.

The querying module 403 may indicate that the call may not qualify to be rerouted, in which case the call would be forwarded to a routing module 407 and routed through a means known in the art.

The above description merely provides a disclosure of particular embodiments of the claimed invention and is not intended for the purposes of limiting the same thereto. As such, this disclosure is not limited to only the above-described embodiments. Rather, it is recognized that one skilled in the art could conceive alternative embodiments that fall within the scope of the invention.

We claim:

1. A method for routing a call along a signaling path through route advance from a first network to a second network comprising:
originating a call having an origination point in a first form through a first region;
routing said call to an originating mobile switching center;
routing said call to a first internet protocol tandem associated with said first region;
forwarding said call to a second internet protocol tandem associated with a second region;
determining if said call qualifies as a call that may be terminated in a second form; and
if said call does qualify to be terminated in said second form, rerouting said call back to said originating mobile switching center and connecting said call to said termination point in a second form.

2. The method according to claim 1 further comprising querying a number portability database in order to assist in determining if said call qualifies as a call that may be terminated in said second form.

3. The method according to claim 2 wherein said number portability database is locally associated with said second region.

4. The method according to claim 1 wherein said first form is packet based.

5. The method according to claim 1 wherein rerouting said call includes forwarding a packet-to-circuit indicator that signals said originating mobile switching center to reroute said call via a circuit network.

6. The method according to claim 1 wherein said call qualifies as a call that may be terminated in said first form if said termination point and said origination point that are associated with a common service provider.

7. The method according to claim 1 wherein said second form is circuit based.

8. The method according to claim 1 further comprising if said call does not qualify to be routed in said second form routing said call to a second mobile switching center that is associated with said termination point.

9. The method according to claim 1 wherein said call includes a signaling path.

10. A system for providing network support route advancing for a call in one form to another comprising:
a mobile switching center configured to forward a call and convert said call from a packet based call to a circuit based call;
a first internet protocol tandem in a first region that receives said call from said mobile switching center;
a second internet protocol tandem in a second region configured to receive said call from said first internet protocol tandem and implement predetermined criteria in order to qualify a call as a call that is to be converted to a circuit based call; and
a database that stores qualifying information for said second region.

11. The system according to claim 10 wherein said qualifying information includes connection information.

12. The system according to claim 10 wherein said database is a regional wireless number portability database.

13. The system according to claim 10 further comprising a home location register configured to locate a termination point for said call when said call does not qualify as a call that is to be converted to a circuit based call.

14. The system according to claim 10 wherein said call qualification is based at least in part on whether the call is an intra-network call.

15. A system for hierarchical call routing with a look-ahead mechanism comprising:
a mobile switching center in a first region configured to route a call over a packet network, and reroute said call over a circuit network if said call meets a rerouting criteria;
a query module configured to query a database in order to determine if said call meets said rerouting criteria; and
a rerouting module that reroutes the call back to said mobile switching center if said call meets said rerouting criteria.

16. The system according to claim 15 further comprising a home location register that is queried in order to find which mobile switching center said call's termination point is visiting in order to connect said call if said call does not meet rerouting criteria.

17. The system according to claim 15 wherein said database is a wireless number portability database.

18. The system according to claim 15 wherein said circuit network includes the public switched telephone network.

19. The system according to claim 15 wherein said call has an origination point and a termination point and said rerouting criteria is met if said origination point and termination point are not supported by a common network provider.
